(19) United States
(12) Patent Application Publication
(10) Pub. No.: US 2009/0267278 A1
(43) Pub. Date: Oct. 29, 2009

(54) CLAMPING FORK WITH REPEATABLE REFERENCE AND TWO STEP CLAMPING FORK

(76) Inventors: Joseph Christman, San Jose, CA (US); Ovidio Horacio Anton, Cupertino, CA (US)

Correspondence Address: Roeder & Broder LLP, 5560 Chelsea Avenue, La Jolla, CA, 92037, US

(21) Appl. No.: 12/111,111

(22) Filed: Apr. 28, 2008

(51) Int. Cl. B23Q 3/06

(52) U.S. Cl. 269/97

(57) ABSTRACT

A fork assembly (18) for mounting a pedestal riser (16) to an apparatus frame (12) of a precision apparatus (10) includes a fork bracket (20), a bracket retainer (228), a fork engager (22), and an engager attacher (230). The bracket retainer (228) fixedly secures the fork bracket (20) to the apparatus frame (12). The fork engager (22) engages the pedestal riser (16). The engager attacher (230) attaches the fork engager (22) to the fork bracket (20) while allowing for movement between the fork engager (22) and the fork bracket (20). With this, design, the fork bracket (20) can be fixedly secured to the apparatus frame (12) at a given location, while the fork engager (22) can be selectively moved to selectively attach and detach the pedestal riser (16).

### BACKGROUND

Optical instruments and assemblies such as microscopes, telescopes, lasers, and fiber optic coupling and launch applications require a way of precisely assembling the optics.

One way of assembling optics is a breadboard that includes a planar surface having plurality of spaced apart, internally threaded apertures for mounting the optical components. Commonly, a clamping fork is used to secure a pedestal riser holding the optical component to the breadboard. One type of clamping fork includes a rigid fork body having (i) a jaw for engaging a pedestal flange of the pedestal riser, and (ii) a slot for receiving a screw. In this design, the screw can be inserted into the slot and threaded into the breadboard to urge the fork body against the breadboard. Further, in this design, urging the fork body against the breadboard causes the jaw to urge the pedestal flange against the breadboard to secure the pedestal to the breadboard. Thus, existing clamping forks are relatively easy to use because one screw secures both the fork body and the pedestal riser to the breadboard.

Unfortunately, existing clamping forks are not entirely satisfactory. For example, with existing clamping forks, it is not very easy to remove the pedestal riser and exactly reattach the pedestal riser in the same position.

### SUMMARY

The present invention is directed to a fork assembly for mounting a pedestal riser to an apparatus frame of a precision apparatus. The fork assembly includes a fork bracket, a bracket retainer, a fork engager, and an engager attacher. The bracket retainer fixedly secures the fork bracket to the apparatus frame. The fork engager engages the pedestal riser. The engager attacher attaches the fork engager to the fork bracket while allowing for movement between the fork engager and the fork bracket. With this design, in certain embodiments, the fork bracket can be fixedly secured to the apparatus frame at a given location, while the fork engager can be selectively moved to selectively attach and detach the pedestal riser. Thus, the features controlling the location of the fork bracket on the apparatus frame is completely independent from the features that secure the pedestal riser to the apparatus frame. This allows the optical component to be added to or removed from the fork assembly without moving the fork bracket and loosening the position of the fork bracket. This allows for the relatively easy arrangement, assembly, modification, and/or repair of the precision apparatus.

In one embodiment, the fork assembly includes an engager mover that selectively moves the fork engager towards the apparatus frame so that the pedestal riser engages the apparatus frame. More specifically, the engager mover can selectively urge a portion of the fork engager away from the fork bracket. For example, the engager mover can include a screw that is rotated to move a portion of the fork engager away from the fork bracket.

In certain designs, the fork engager engages a pedestal flange of the pedestal riser. Further, the fork engager can be somewhat “V” shaped.

In one embodiment, the bracket retainer includes a spherical surface that engages the fork engager to retain the fork engager while allowing for movement of the fork engager relative to the fork bracket.

The present invention is also directed to a precision apparatus that includes an apparatus frame, a pedestal riser, and the fork assembly. Further, the present invention is directed to a method for mounting a pedestal riser that includes the steps of: (i) providing a fork bracket; (ii) fixedly securing the fork bracket to the apparatus frame with a bracket retainer; (iii) providing a fork engager that engages the pedestal riser; and (iv) attaching the fork engager to the fork bracket with a engager attacher that allows for movement between the fork engager and the fork bracket.

### BRIEF DESCRIPTION OF THE DRAWINGS

The novel features of this invention, as well as the invention itself, both as:to its structure and its operation, will be best understood from the accompanying drawings, taken in conjunction with the accompanying description, in which similar reference characters refer to similar parts, and in which:

FIG. 1 is a simplified top perspective illustration of a portion of a precision apparatus having features of the present invention;

FIG. 2A is a bottom perspective view of a pedestal, and a fork assembly having features of the present invention;

FIGS. 2B and 2C are alternative exploded perspective views of the pedestal and the fork assembly of FIG. 2A;

FIG. 3A is a bottom perspective view of a pedestal, and another embodiment of a fork assembly having features of the present invention;

FIGS. 3B and 3C are alternative exploded perspective views of the pedestal and the fork assembly of FIG. 3A

FIG. 4A is an exploded, bottom perspective view of another embodiment of the fork assembly;

FIG. 4B is a bottom view, FIG. 4C is a top view, and FIG. 4D is an end view of a portion of the fork assembly of FIG. 4A;

FIG. 4E is a cut-way view taken on line 4E-4E in FIG. 4C;

FIG. 4F is a cut-way view taken on line 4F-4F in FIG. 4C;

FIGS. 4G and 4H are alternative views of a resilient spacer assembly having features of the present invention; and

FIGS. 4I, 4J, and 4K are simplified illustrations of the fork at alternative positions.

### DESCRIPTION

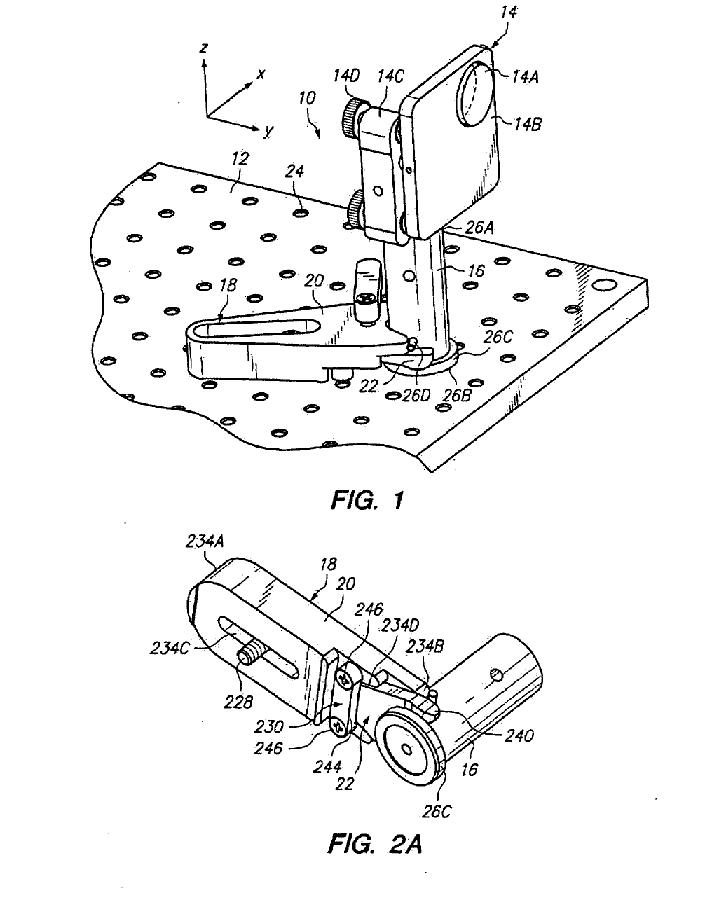

Referring to FIG. 1, the present invention is directed to a precision apparatus 10 that, for example, can be used in manufacturing, technical or scientific instruments. Applications include the collimation of light sources such as fibers, LED's or lasers, focusing of light into fibers, spectroscopic instruments, telescopic beam expanders/reducers, spatial filters, and inspection systems such as telescopes, microscopes, especially for custom designs and prototypes.

The design and orientation of the components of the precision apparatus 10 can be changed to suit the requirements of the precision apparatus 10. FIG. 1 is a simplified top perspective view of one embodiment of the precision apparatus 10. In this embodiment, the precision apparatus 10 includes an apparatus frame 12, an optical component 14, a pedestal riser 16, and a fork assembly 18 (sometimes referred to as a “clamping fork”) that selectively secures the pedestal riser 16 and the optical component 14 to the apparatus frame 12.

As an overview, in certain embodiments, the fork assembly 18 includes a fork bracket 20 that is fixedly secured to the apparatus frame 12, and a fork engager 22 that can be selectively moved relative to the fork bracket 20 to selective urge the pedestal riser 16 against the apparatus frame 12 to selectively secure the pedestal riser 16 to the apparatus 12. With this design, in certain embodiments, the fork bracket 20 can be fixedly secured to the apparatus frame 12 at a given location, while the fork engager 22 can be selectively moved to selectively attach and detach the pedestal riser 16 and the optical component 14. Thus, the features controlling the location of the fork bracket 20 on the apparatus frame 12 is completely independent from the features that secure the pedestal riser 16 to the apparatus frame 12. This allows the optical component 14 to be added to or removed from the fork assembly 18 without moving the fork bracket 20 and loosening the position of the fork bracket 20.

It should be noted that many of the Figures include an orientation system that illustrates an X axis, a Y axis that is orthogonal to the X axis, and a Z axis that is orthogonal to the X and Y axes. It should be noted that these axes can also be referred to as the first, second, and third axes.

The apparatus frame 12 retains and/or supports the other components of the precision apparatus 10. In one embodiment, the apparatus frame 12 is generally rectangular, flat plate shaped, is made of a rigid material, and includes a plurality of spaced apart, frame mounts 24 that are arranged in a plurality of rows. For example, the apparatus frame 12 can be a breadboard or an optical table. Further, in FIG. 1, each of the frame mounts 24 is an internally threaded aperture. Alternatively, for example, one or more of the frame mounts 24 can be a threaded rod or another type of fastener.

The type of optical components 14 used in the precision apparatus 10 can be varied according to the requirements of the precision apparatus 10. Non-exclusive examples of optical components 14 include optical filters, polarizers, lens, mirrors, emitters, sensors, detectors, prisms, filter wheels, light sources, beam steerers, diagnostic elements, beamsplitters, diagnostic tools (e.g. fluorescent cards, power meters, alignment guides, beam profilers, detectors and cameras), or another type of optical component.

In FIG. 1, the optical component 14 includes (i) a lens 14A, (ii) a lens plate 14B that retains the lens 14A, (iii) a mounting bracket assembly 14C that retains the lens plate 14B and that includes a plurality of adjusters 14D for adjusting the position of the lens 14A and lens plate 14B along the Y axis, about the X axis and about the Z axis, and (iv) a component fastener (not shown) that fixedly secures the mounting bracket assembly 14C to the top of the pedestal riser 16. As mentioned above, with the fork assembly 18 provided herein, the optical components 14 can be easily added, removed, adjusted or repaired.

The pedestal riser 16 extends between the optical component 14 and the apparatus frame 12 and maintains the optical component 14 above (along the Z axis) the apparatus frame 12. In FIG. 1, the pedestal riser 16 is generally right cylindrical shaped and includes a distal end 26A that engages the optical component 14, and a proximal end 26B that engages the apparatus frame 12. Additionally, the pedestal riser 16 can include a pedestal flange 26C that is engaged by the fork assembly 18. In FIG. 1, the pedestal flange 26C is generally ring shaped and is located near the proximal end 26B. Alternatively, for example, the pedestal riser 16 can have a generally rectangular shaped cross-section.

Additionally, the pedestal riser 16 can include a pedestal stop 26D that engages the fork assembly 18. In one embodiment, the pedestal stop 26D is a cylindrical rod (or a pair of pins) that extends transversely through the pedestal riser 16. In this embodiment, when the pedestal stop 26D engages the fork assembly 18, the pedestal riser 16 is inhibited from rotating about the Z axis. With this design, the pedestal riser 16 can be removed from the fork assembly 18 and subsequently re-added in a repeatable fashion. Stated in another fashion, when the pedestal stop 26D engages the fork assembly 18, the rotational position of the pedestal riser 16 is set and repeatable.

In one embodiment, the pedestal stops 26D engage a pair of spaced apart fork contacts 18A (only one is illustrated in FIG. 1). In this embodiment, the fork contacts 18A are a part of the fork bracket 20. Alternatively, the fork contacts 18A and/or the pedestal stop 26D can have a different configuration than that illustrated in FIG. 1. For example, the fork contacts 18A and/or the pedestal stop 26D can include one or more pins, balls, or “V” shaped grooves that assist in precise alignment in the X axis and the Y axis.

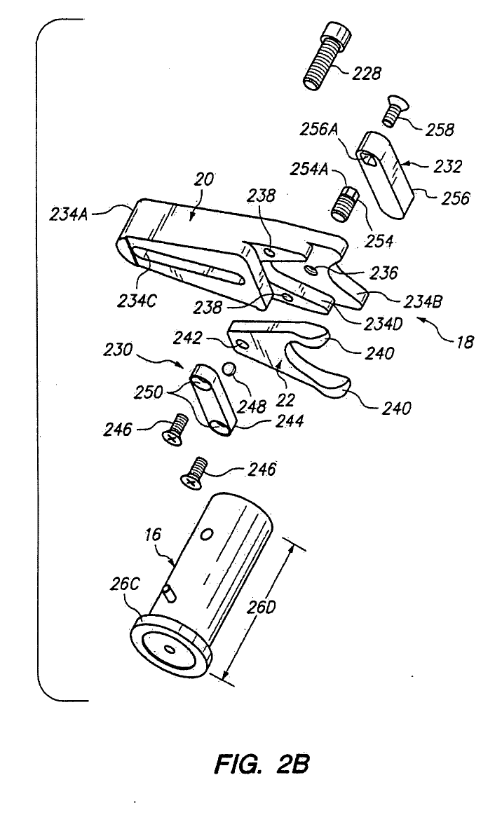

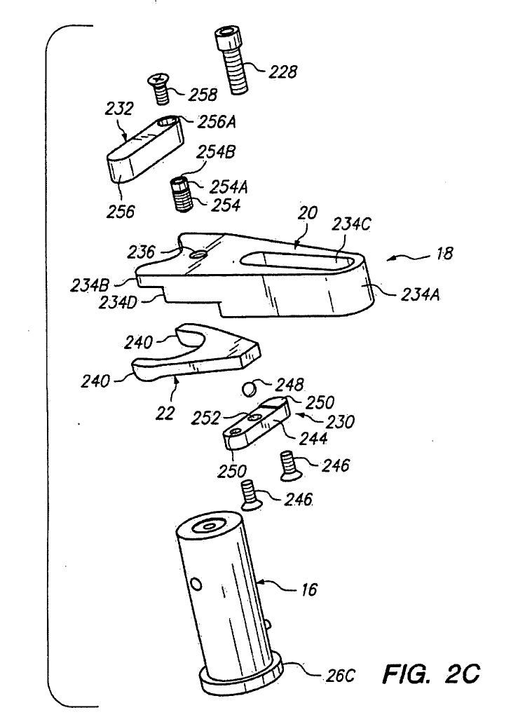

Further, the pedestal riser 16 has a pedestal length 26E (illustrated in FIG. 2B) between the ends 26A, 26B that sets the distance between the optical component 14 and the apparatus frame 12. The pedestal length 26E can be varied to achieve the desired height of the optical component 14. Typically, pedestal risers 16 of a variety of different lengths are available to the designer of the precision assembly 10. For example, the pedestal length 26E can be between approximately one-half to six inches. Further, the pedestal riser 16 can have a diameter of approximately one inch. Alternatively, other lengths and thicknesses can be utilized.

The pedestal riser 16 can be made of a rigid material, such as plastic, steel, or aluminum.

The fork assembly 18 selectively secures the pedestal riser 16 to the apparatus frame 12. Further, the fork assembly 18 allows the pedestal riser 16 to be clamped almost anywhere on the apparatus frame 12. This allows for great flexibility in clamping the pedestal riser 16 while providing great stability for the pedestal riser 16.

FIG. 2A is a bottom perspective view and FIGS. 2B and 2C are alternative exploded perspective views of the pedestal riser 16 and the fork assembly 18. In this embodiment, the fork assembly 18 includes the fork bracket 20, the fork engager 22, a bracket retainer 228, an engager attacher 230, and an engager mover 232 that cooperate to secure the pedestal riser 16 to the apparatus frame 12 (illustrated in FIG. 1). The design and positioning of each of these components can be varied pursuant to the teachings provided herein.

In one embodiment, the fork bracket 20 is somewhat rectangular beam shaped and includes a first end 234A and an opposed second end 234B. In FIGS. 2A-2C, the first end 234A is generally arched shaped and the second end 234B is generally “V” shaped. Additionally, the fork bracket 20 includes (i) a retainer slot 234C that receives the bracket retainer 238, (ii) a V shaped engager guide 234D that receives a portion of the fork engager 22, (iii) an internally threaded aperture 236 that defines a portion of the engager mover 232, and (iv) a pair of internally threaded apertures 238 that define a portion of the engager attacher 230. In one embodiment, when the bracket retainer 228 is loosened, the retainer slot 234C allows the fork bracket 20 to slide relative to the bracket retainer 228 and the apparatus frame 12 so that the fork assembly 18 can be positioned in a variety of locations relative to the apparatus frame 12.

The fork bracket 20 can be made of a rigid material, such as plastic, steel, or aluminum.

The fork engager 22 engages the pedestal flange 26C to urge the pedestal flange 26C against the apparatus frame 12. In one embodiment, the fork engager 22 is somewhat “V” shaped and includes a pair of spaced apart pedestal contacts 240 that engage the pedestal flange 26C. In this embodiment, the pedestal contacts 240 can be positioned on opposite sides of the pedestal riser 16 with the pedestal riser 16 therebetween. Additionally, as illustrated in FIG. 2B, the fork engager 22 includes a semi-spherical shaped engager groove 242 that forms a portion of the engager attacher 230.

The fork engager 22 can be made of a rigid material, such as plastic, steel, or aluminum.

The bracket retainer 228 selectively and fixedly secures the fork bracket 20 to apparatus frame 12. In one, non-exclusive embodiment, the bracket retainer 228 is a threaded screw (e.g. a one-quarter by twenty cap screw) that can be threaded into the apparatus frame 12 to urge the fork bracket 20 against the apparatus frame 12 to secure the fork bracket 20 to the apparatus frame 12.

The engager attacher 230 attaches and secures the fork engager 22 to the fork bracket 20 while allowing for movement between the fork engager 22 and the fork bracket 20. With this design, the fork bracket 20 can be fixedly secured to the apparatus frame 12 at a given location, while the fork engager 22 can be selectively moved to selectively attach and detach the pedestal riser 16 and the optical component 14 (illustrated in FIG. 1).

In one embodiment, the engager attacher 230 includes a capture bracket 244, a pair of fasteners 246, and a steel spherical ball 248. In this embodiment, the capture bracket 244 includes a pair of apertures 250 that receive the fasteners 246 and a semi-spherical shape groove 252 in the side that faces the fork engager 22. Further, the fasteners 246 (e.g. a threaded screw) extend through the apertures 250 in the capture bracket 244 and thread into the threaded apertures 238 of the fork bracket 22 to secure the capture bracket 244 to the fork bracket 22. Moreover, in this embodiment, the ball 248 fits in the groove 252 of the fork bracket 20 and the engager groove 242 of the fork engager 22 to attach the fork engager 22 to the capture bracket 244 and the fork bracket 20 while allowing for movement of the fork engager 22 relative to the fork bracket 20. It should be noted that in the assembled position illustrated in FIG. 2A, the fork engager 22 is partly positioned in the engager guide 234D so that the engager guide 234D can limit the amount of movement of the fork engager 22 relative to the fork bracket 20.

The engager mover 232 selectively inhibits movement between the fork engager 22 and the fork bracket 20. In one embodiment, the engager mover 232 moves the fork engager 22 towards the apparatus frame 12 so that the pedestal flange 26C engages the apparatus frame 12 to secure the pedestal riser 16 to the apparatus frame 12. In one embodiment, the engager mover 232 includes (i) an externally threaded member 254 that threads through the threaded aperture 236 in the fork bracket 200 and engages the fork engager 22, (ii) a member beam 256, and (iii) a member attacher 258 that secures the member beam 256 to the member 254. In this embodiment, a top end 254A of the member 254 is octagonal shaped 254A and includes an internally threaded surface 254B. Further, the member beam 256 includes an opening 256A that is octagonal shaped at the bottom to receive the top end 254A of the member 254 and that is tapered at the top to receive the member attacher 258 (e.g. a screw). With this design, the member attacher 258 threads into the internally threaded surface 254B to secure the member beam 256 to the threaded member 254.

With this design, rotation of the member beam 256 in a first rotational direction causes the threaded member 254 to engage the fork engager 22 and move the fork engager 22 downward away from the fork bracket 20 and against the apparatus frame 12. Alternatively, rotation of the member beam 256 in a second rotational direction causes the threaded member 254 to disengage from the fork engager 22 and allows the fork engager 22 to move towards the fork bracket 20 and away from the apparatus frame 12. Thus, the features controlling the location of the fork bracket 20 is completely independent from the features that secure the pedestal riser 16 to the apparatus frame 12. This allows the optical component 14 to be added to or removed from the fork assembly 18 without moving the fork bracket 20 and loosing the position of the fork bracket 20.

In another embodiment, the combination of the member 254, the member beam 256, and the member attacher 258 can be replaced with a screw that threads into the internally threaded aperture 236 of the fork bracket 20.

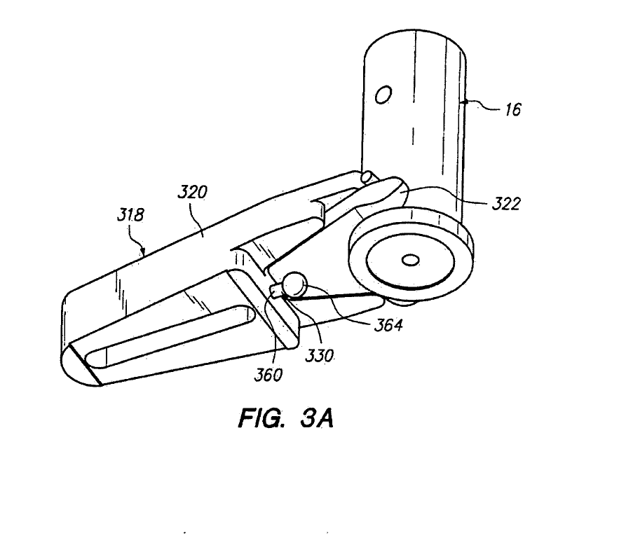

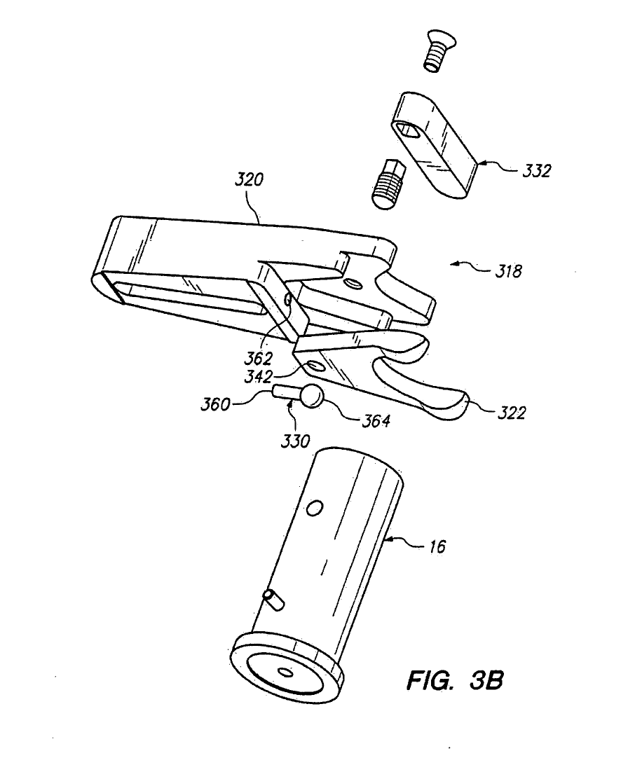

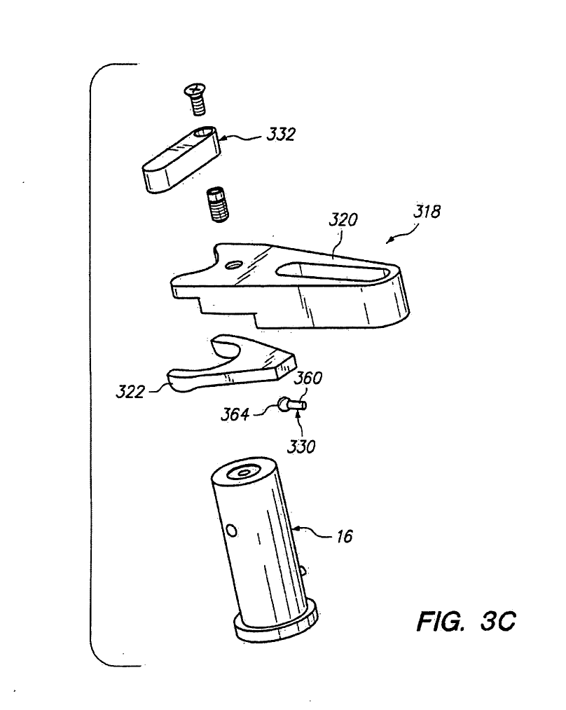

FIG. 3A is a bottom perspective view and FIGS. 3B and 3C are alternative exploded perspective views of the pedestal riser 16 and another embodiment of a fork assembly 318 having features of the present invention. In this embodiment, the fork assembly 318 includes a fork bracket 320, a fork engager 322, a bracket retainer (not shown), and an engager mover 332 that are similar to the corresponding components described above in FIGS. 2A-2C and an engager attacher 330 that is slightly different than the corresponding component described above.

The engager attacher 330 again attaches and secures the fork engager 322 to the fork bracket 320 while allowing for movement between the fork engager 322 and the fork bracket 320. With this design, the fork bracket 320 can be fixedly secured to the apparatus frame 12 (illustrated in FIG. 1) at a given location, while the fork engager 322 can be selectively moved to selectively attach and detach the pedestal riser 16 and the optical component 14 (illustrated in FIG. 1).

In this embodiment, the engager attacher 330 includes a tooling ball having a shaft section 360 that extends into an aperture 362 in the fork bracket 320 and a spherical ball section 364 that extends away from the shaft section 360 and the fork bracket 320. In this embodiment, the ball section 364 is positioned in the engager groove 342 of the fork engager 322 to attach the fork engager 322 to the fork bracket 320.

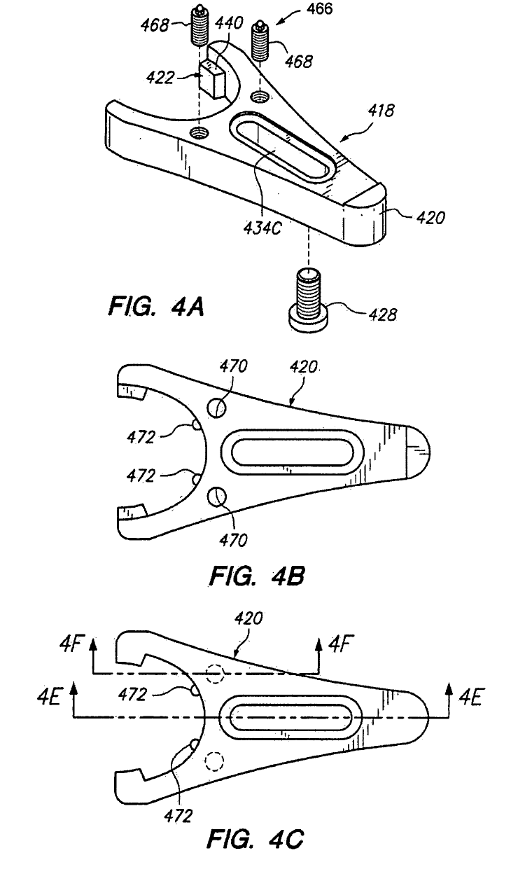

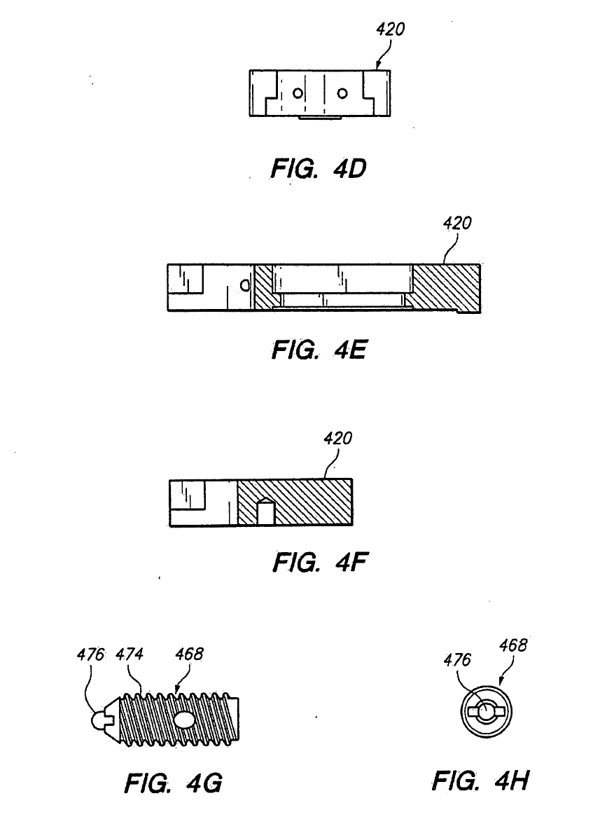

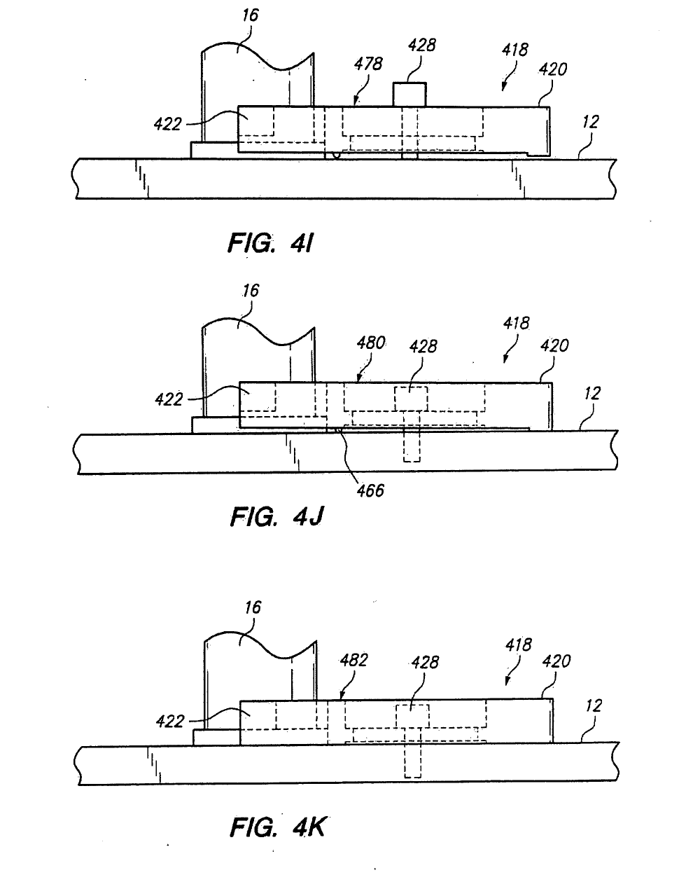

FIG. 4A is an exploded, bottom perspective view of another embodiment of a fork assembly 418 that can secure the pedestal riser 16 (illustrated in FIG. 1) to the apparatus frame 12 (illustrated in FIG. 1). In this embodiment, the fork assembly 418 includes a fork bracket 420, a bracket retainer 428 and a resilient spacer assembly 466. The design of each of these components can vary pursuant to the teachings provided herein.

In this embodiment, the fork bracket 420 includes the fork engager 422 that is integrated into a one piece body that also includes the retainer slot 434C for receiving the bracket retainer 428. In this embodiment, the fork engager 422 again includes a pair of spaced apart pedestal contacts 440 (only one is shown) that engage the pedestal riser 16.

The bracket retainer 428 again selectively and fixedly secures the fork bracket 420 to apparatus frame 12. In this embodiment, the bracket retainer 428 is a threaded screw that can be threaded into the apparatus frame 12.

The resilient spacer assembly 466 can maintain a portion of the fork bracket 420 away from the apparatus frame 12 so that the pedestal riser 16 can be added to apparatus frame 12. Stated in another fashion, the resilient spacer assembly 466 maintains a portion of the fork bracket 420 away from the apparatus frame 12 so that pedestal riser 16 can be removed from the fork engager 422. The design and location of the spacer assembly 466 can be varied pursuant to the teachings provided herein. In FIG. 4A, the resilient spacer assembly 466 includes a pair of spaced apart resilient members 468 that are positioned intermediate the pedestal contacts 440 and the retainer slot 434C.

As an overview, with the design illustrated in FIG. 4A, (i) when the bracket retainer 428 is loosened, the pedestal riser 16 can be removed from or added to the fork bracket 420, and the fork bracket 420 can be moved relative to the bracket retainer 428 along the retainer slot 434C; (ii) when the bracket retainer 428 is partly tightened, the resilient spacer assembly 466 maintains a portion of the fork bracket 420 away from the apparatus frame 12 so that the pedestal riser 16 can be added or removed, but at this position, the fork bracket 420 is inhibited from being moved relative to the bracket retainer 428 along the retainer slot 434C; and (iii) when the bracket retainer 428 is fully tightened, the fork bracket 420 secures the pedestal riser 16 to the apparatus frame 12 and the fork bracket 420 is inhibited from being moved relative to the bracket retainer 428 along the retainer slot 434C. With this design, the same bracket retainer 428 can be used in a two step locking procedure where (i) the fork bracket 420 is secured to the apparatus frame 12, and (ii) the fork bracket 420 retains the pedestal riser 16. This simplifies the assembly of the system and allows for improved accuracy in positioning the pedestal riser 16.

FIG. 4B is a bottom view, FIG. 4C is a top view, and FIG. 4D is an end view of the fork bracket 420 of FIG. 4A. In this embodiment, the fork bracket 420 also includes a pair of spaced apart internally threaded apertures 470 that receive the resilient members 468 (illustrated in FIG. 4A). Further, the fork bracket 420 includes a pair of spaced apart, arch shaped alignment pads 472 that engage the pedestal riser 16 to maintain the positioning of the pedestal riser 16.

FIG. 4E is a cut-way view taken on line 4E-4E in FIG. 4C and FIG. 4F is a cut-way view taken on line 4F-4F in FIG. 4C of the fork bracket 420.

FIGS. 4G and 4H are alternative views of one resilient member 468 having features of the present invention. In this embodiment, the resilient member 468 includes (i) an externally threaded surface 474 that can be threaded into one of the internally threaded apertures 470 of the fork bracket 420, and (ii) a spring loaded pin 476. In this embodiment, the pin 476 extends away form the fork bracket 420 when the resilient member 468 is threaded into the fork bracket 420.

Alternatively, the resilient member 468 can have a different design. For example, the resilient member 468 can be rubber or elastic pad or another type of spring or resilient device.

FIGS. 4I, 4J, and 4K are simplified illustrations of the fork assembly 418 at alternative positions. More specifically, the bracket retainer 428 can move fork bracket 420 between at least a first position 478 (illustrated in FIG. 4I), a second position 480 (illustrated in FIG. 4J), and a third position 482 (illustrated in FIG. 4K). In the first position 478, the bracket retainer 428 is loosened, and the fork bracket 420 can be moved relative to the apparatus frame 12 and the pedestal riser 16 (e.g. the fork engager 422 does not engage the riser 16). In the second position 480, the bracket retainer 428 is partly tightened, and the fork bracket 420 is inhibited from moving relative to the apparatus frame 12, but the resilient spacer assembly 466 maintains a portion of the fork bracket 420 away from the apparatus frame 12 so that pedestal riser 16 can be removed from the fork engager 422 (e.g. the fork engager 422 does not engage the riser 16). In the third position 482, the bracket retainer 428 secures the fork bracket 420 to the apparatus frame 12, and the fork engager 422 engages and urges the pedestal riser 16 towards the apparatus frame 12 to retain the pedestal riser 16.

While the particular apparatus 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A fork assembly for mounting a pedestal riser to an apparatus frame of a precision apparatus, the fork assembly comprising:
a fork bracket that is adapted to be secured to the apparatus frame;
a fork engager that engages the pedestal riser;
an engager attacher that attaches the fork engager to the fork bracket while allowing for movement between the fork engager and the fork bracket; and
an engager mover that selectively moves the fork engager towards the apparatus frame so that the pedestal riser engages the apparatus frame.

2. The fork assembly of claim 1 further comprising a bracket retainer that fixedly secures the fork bracket to the apparatus frame.

3. The fork assembly of claim 1 wherein the engager mover selectively urges a portion of the fork engager away from the fork bracket.

4. The fork assembly of claim 3 wherein the engager mover includes a screw that is rotated to move a portion of the fork engager away from the fork bracket.

5. The fork assembly of claim 1 wherein the fork engager engages a pedestal flange of the pedestal riser.

6. The fork assembly of claim 5 wherein the fork engager is somewhat “V” shaped.

7. The fork assembly of claim 1 wherein the bracket retainer includes a spherical surface that engages the fork engager to retain the fork engager while allowing for movement of the fork engager relative to the fork bracket.

8. The combination comprising a pedestal riser and the fork assembly of claim 1, wherein the pedestal riser includes a pedestal stop that engages the fork assembly to inhibit rotation of the pedestal riser relative to the fork assembly.

9. A precision apparatus comprising an apparatus frame, a pedestal riser, and the fork assembly of claim 1 securing the pedestal riser to the apparatus frame.

10. A fork assembly for mounting a pedestal riser to an apparatus frame of a precision apparatus, the pedestal riser including a pedestal flange, the fork assembly comprising:
a fork bracket;
a bracket retainer that fixedly secures the fork bracket to the apparatus frame;
a fork engager that engages the pedestal flange;
an engager attacher that attaches the fork engager to the fork bracket while allowing for movement between the fork engager and the fork bracket; and
an engager mover that selectively urges a portion of the fork engager away from the fork bracket and moves the fork engager towards the apparatus frame so that:the pedestal riser engages the apparatus frame.

11. The fork assembly of claim 10 wherein the engager mover includes a screw that is rotated to move a portion of the fork engager away from the fork bracket.

12. The fork assembly of claim 10 wherein the fork engager is somewhat “V” shaped.

13. The fork assembly of claim 10 wherein the bracket retainer includes a spherical surface that engages the fork engager to retain the fork engager while allowing for movement of the fork engager relative to the fork bracket.

14. A precision apparatus comprising an apparatus frame, a pedestal riser, and the fork assembly of claim 10 securing the pedestal riser to the apparatus frame.

15. A method for mounting a pedestal riser to an apparatus frame of a precision apparatus, the method comprising the steps of:
providing a fork bracket;
fixedly securing the fork bracket to the apparatus frame with a bracket retainer;
providing a fork engager that engages the pedestal riser; and
attaching the fork engager to the fork bracket with a engager attacher that allows for movement between the fork engager and the fork bracket.

16. The method of claim 15 further comprising the step of selectively moving the fork engager towards the apparatus frame with an engager mover so that the pedestal riser engages the apparatus frame.

17. The method of claim 16 wherein the step of selectively moving includes selectively urges a portion of the fork engager away from the fork bracket.

18. The method of claim 15 wherein the step of providing a fork engager includes the step of providing a fork engager that is somewhat “V” shaped.

19. The method of claim 15 wherein the step of attaching including the step of providing a spherical surface that engages the fork engager to retain the fork engager while allowing for movement of the fork engager relative to the fork bracket.

20. A fork assembly for mounting a pedestal riser to an apparatus frame of a precision apparatus, the fork assembly comprising:
a fork bracket including a fork engager that is adapted to engage the pedestal riser;
a bracket retainer that fixedly secures the fork bracket to the apparatus frame; and
a resilient spacer assembly that maintains a portion of the fork bracket away from the apparatus frame so that pedestal riser can be removed from the fork engager.

21. The fork assembly of claim 20 wherein the bracket retainer can move the fork bracket between at least a first position, a second position and a third position, and wherein in the first position the fork bracket can be moved relative to the apparatus frame and the pedestal riser, in the second position the fork bracket is secured to the apparatus frame but the resilient spacer assembly maintains a portion of the fork bracket away from the apparatus frame so that pedestal riser can be removed from the fork engager, and in the third position the fork bracket is secured to the apparatus frame and the fork engager retains the pedestal riser.
